(19) United States
(12) Patent Application Publication
(10) Pub. No.: US 2025/0225953 A1
(43) Pub. Date: Jul. 10, 2025

(54) DISPLAY DEVICE AND THE OPERATION METHOD THEREOF

(71) Applicant: SAMSUNG ELECTRONICS CO., LTD., Suwon-si (KR)

(72) Inventors: Hyukjoong KWON, Suwon-si (KR); Junhyeong KIM, Suwon-si (KR)

(73) Assignee: SAMSUNG ELECTRONICS CO., LTD., Suwon-si (KR)

(21) Appl. No.: 19/089,974

(22) Filed: Mar. 25, 2025

Related U.S. Application Data
(63) Continuation of application No. PCT/KR2023/012728, filed on Aug. 28, 2023.

(30) Foreign Application Priority Data
Oct. 20, 2022 (KR) 10-2022-0135871

(51) Int. Cl. G09G 5/36

(52) U.S. Cl. CPC G09G 5/36; G09G 2340/0407; G09G 2340/10; G09G 2340/125

(57) ABSTRACT

A display device may include: memory storing instructions; and at least one processor operatively connected to the memory and including at least one graphic buffer and at least two scalers, wherein the at least one processor is configured to execute the instructions to: obtain first graphic data from the memory; determine a size of the at least one graphic buffer to be upscaled by the at least two scalers, based on a resolution of the first graphic data and a resolution of the display device; render the first graphic data to the at least one graphic buffer to generate rendered data; divide the at least one graphic buffer into at least two division areas based on a specification of the at least two scalers; and upscale the rendered data of the at least two division areas using the at least two scalers to obtain at least two upscale graphic data.

### CROSS-REFERENCE TO RELATED APPLICATIONS

This application is a continuation application of International Application No. PCT/KR2023/012728, filed on Aug. 28, 2023, in the Korean Intellectual Property Receiving Office, which claims priority to Korean Patent Application No. 10-2022-0135871, filed on Oct. 20, 2022, in the Korean Intellectual Property Office, the disclosures of which are incorporated by reference herein in their entireties.

### BACKGROUND

### 1. Field

Embodiments of the disclosure relate to a display device and operation method thereof. Specifically, embodiment of the disclosure relate to a device and an operation method thereof for displaying graphics while minimizing deterioration of image quality and performance.

### 2. Description of Related Art

With the advancement of technology for display devices, the demand for high-resolution video services has recently increased. TVs and monitors may have pre-defined output resolutions and output ratios, and TVs and monitors may use display systems with, e.g., 2K (full high definition, FHD) and 4K (ultra HD, UHD) resolutions at a 16:9 ratio. Recently, display systems that support various resolutions, such as 8K, wide quad HD (WQHD), and double UHD (DUHD) are being commercialized. Also being developed are display systems that support multiple ratios, such as 21:9 and 32:9.

In this regard, graphics and images displayed through the display device may also have various resolutions. When the resolution of the original graphics and images displayed through the display device is higher than the resolution of the display device, no issue occurs. However, if the resolution of the original graphics and images is lower than the resolution of the display device, degradation of image quality, such as a blur, occurs, causing the user to feel uncomfortable. To address such issues that arise when the resolution of the original graphics and images is lower than the resolution of the display device, an upscaling technique for increasing the resolution of the original graphics and images may apply.

### SUMMARY

A TV or a monitor may include a buffer and a scaler for rendering the original graphics to perform upscaling on the original graphics. However, if the resolution of the original graphics cannot be processed according to the specifications of the scaler, the original graphics need to be downscaled to address the issue, causing degradation of image quality.

Embodiments of the disclosure provide a device and an operation method thereof, for adaptively upscaling an original graphics having various resolutions according to the specifications of a display device.

Embodiments of the disclosure also provide a device and an operation method thereof, for displaying graphics without degradation of image quality when displaying graphic data on a display device through a single view (e.g., display only one application on the screen) and multi-view (e.g., display a plurality of applications on the screen).

According to an aspect of the disclosure, a display device may include: memory storing instructions; and at least one processor operatively connected to the memory and including at least one graphic buffer and at least two scalers, wherein the at least one processor is configured to execute the instructions to: obtain first graphic data from the memory; determine a size of the at least one graphic buffer to be upscaled by the at least two scalers, based on a resolution of the first graphic data and a resolution of the display device; render the first graphic data to the at least one graphic buffer to generate rendered data; divide the at least one graphic buffer into at least two division areas based on a specification of the at least two scalers; upscale the rendered data of the at least two division areas using the at least two scalers to obtain at least two upscale graphic data; obtain output graphic data by mixing the at least two upscale graphic data; and control the display device to display the output graphic data.

The at least one processor may be further configured to execute the instructions to: obtain second graphic data from the memory; and render the first graphic data and the second graphic data to the at least one graphic buffer.

The at least one processor may be further configured to execute the instructions to: superpose and render the first graphic data and the second graphic data at a center position of the at least one graphic buffer.

The at least one graphic buffer may have a ratio corresponding to the resolution of the display device.

The resolution of the first graphic data may be a first ratio (16:9), and the resolution of the display device may be either a second ratio (21:9) or a third ratio (32:9).

The at least two division areas of the at least one graphic buffer may include a first area and a second area, the first area being on a first side of a vertical axis of the at least one graphic buffer, and the second area being on a second side of the vertical axis opposite the first side.

A horizontal length of the at least two upscale graphic data is identical to a half of a horizontal length of the resolution of the display device, and a vertical length of the at least two upscale graphic data is identical to a vertical length of the resolution of the display device.

The display device may further include: a display; and an image input interface. The at least one processor may be further configured to execute the instructions to: receive video data from the image input interface; decode the video data to obtain output video data; and control the display to display a screen in which the output video data and the output graphic data are combined.

The specification of the at least two scalers may include resolutions of the at least two scalers and information about whether the at least two scalers support integer-multiple upscaling.

The at least two scalers may have a same specification.

According to an aspect of the disclosure, a method for operating a display device, may include: obtaining first graphic data from memory; determining a size of at least one graphic buffer to be upscaled by at least two scalers, based on a resolution of the first graphic data and a resolution of the display device; rendering the first graphic data to the at least one graphic buffer to generate rendered data; dividing the at least one graphic buffer into at least two division areas based on a specification of the at least two scalers; upscaling the rendered data of the at least two division areas using the at least two scalers to obtain at least two upscale graphic data; obtaining output graphic data by mixing the at least two upscale graphic data; and displaying the output graphic data using the display device.

The method may further include: obtaining second graphic data from the memory; and rendering the first graphic data and the second graphic data to the at least one graphic buffer.

The method may further include: superposing and rendering the first graphic data and the second graphic data at a center position of the at least one graphic buffer.

The at least one graphic buffer has a ratio corresponding to the resolution of the display device.

The resolution of the first graphic data is a first ratio (16:9), and the resolution of the display device is either a second ratio (21:9) or a third ratio (32:9).

The at least two division areas of the at least one graphic buffer may include a first area and a second area, the first area being on a first side of a vertical axis of the at least one graphic buffer, and the second area being on a second side of the vertical axis opposite the first side.

A horizontal length of the at least two upscale graphic data may be identical to a half of a horizontal length of the resolution of the display device, and a vertical length of the at least two upscale graphic data is identical to a vertical length of the resolution of the display device.

The display device may include a display and an image input interface. The method may further include: receiving video data from the image input interface; decoding the video data to obtain output video data; and displaying a screen in which the output video data and the output graphic data are combined on the display.

The specification of the at least two scalers may include resolutions of the at least two scalers and information about whether the at least two scalers support integer-multiple upscaling.

The at least two scalers may have a same specification.

According to examples disclosed in the disclosure, a display system having various ratios and resolutions may provide various application graphic screens without degradation of image quality of original graphics.

Further, according to examples disclosed in the disclosure, the display device may output the screen at the resolution of the original graphic without downscaling of the original graphic by operating a plurality of scalers in parallel despite limitations (e.g., limitation to the input size of the scaler or limitation to the scaling ratio of the scaler) to the specifications of the scaler.

Further, according to examples disclosed in the disclosure, it is possible to display graphic screens of various applications without degradation of image quality of original graphic without increasing data and logics required to be processed by the graphic processing unit (GPU).

Effects obtainable from the disclosure are not limited to the above-mentioned effects, and other effects not mentioned may be apparent to one of ordinary skill in the art from the following description.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of a display device according to one or more embodiments;

FIG. 2 is a block diagram illustrating a detailed configuration of a display device according to one or more embodiments;

FIG. 3A illustrates an example of upscaling of a display device according to one or more embodiments;

FIG. 3B illustrates an example of upscaling of a display device according to one or more embodiments;

FIG. 4 illustrates an example of upscaling of a display device according to one or more embodiments; and

FIG. 5 illustrates an operation flow of a display device according to one or more embodiments.

In connection with the description of the drawings, the same or similar reference numerals may be used to denote the same or similar elements.

### DETAILED DESCRIPTION

Hereinafter, embodiments of the present invention are described with reference to the accompanying drawings. However, it should be appreciated that the present disclosure is not limited to the embodiments, and all changes and/or equivalents or replacements thereto also belong to the scope of the present disclosure. In the following description, the same/similar reference numerals are used to denote substantially the same components, and no duplicate description is given.

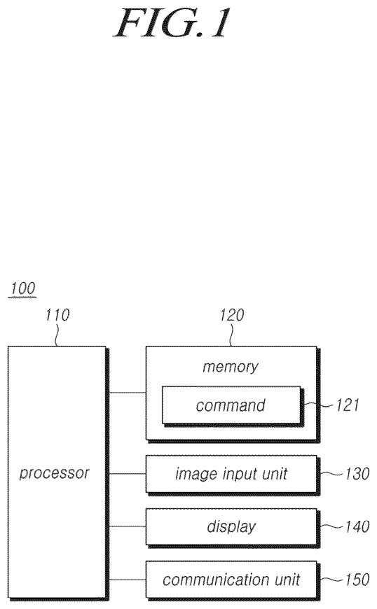

FIG. 1 is a block diagram illustrating a configuration of a display device according to one or more embodiments. The display device of FIG. 1 may be, but is not limited to, a smartphone, a tablet PC, a PC, a smart TV, a mobile phone, a personal digital assistant (PDA), a laptop computer, a media player, a micro server, a digital broadcast terminal, a navigation, a kiosk, a home appliance, or other mobile or non-mobile computing devices. Further, the display device 100 may perform various computing functions, such as real-time video viewing and communication. In the following description, it is assumed that the display device 100 is a TV or a monitor, but this is merely an example and embodiments of the disclosure may be equally applied to electronic devices having a display function.

FIG. 1 is a block diagram illustrating a configuration of a display device according to one or more embodiments.

According to one or more embodiments, the display device 100 may include a processor 110, a memory 120, an image input unit 130 (image input interface), a display 140, and a communication unit 150.

According to one or more embodiments, the memory 120 is a storage medium used by the display device 100 and may store data, such as at least one command 121 or configuration information corresponding to at least one program. The program may include an operating system (OS) program and various application programs.

In one or more embodiments, the memory 120 may include at least one type of storage medium of flash memory types, hard disk types, multimedia card micro types, card types of memories (e.g., SD or XD memory cards), random access memories (RAMs), static random access memories (SRAMs), read-only memories (ROMs), electrically erasable programmable read-only memories (EEPROMs), programmable read-only memories (PROMs), magnetic memories, magnetic disks, or optical discs.

According to one or more embodiments, the image input unit 130 may receive image data through a tuner, an input/output unit, or the communication unit 150. The image input unit 130 may include at least one of the tuner and the input/output unit. The tuner may tune and select only the frequency of the broadcast channel to be received by the display device 100 among many radio components, by amplifying, mixing, and resonating the broadcast signals wiredly/wirelessly received.

The broadcast signal may include video, audio, and additional data (e.g., electronic program guide (EPG)). The tuner may receive broadcast channels (or viewing images) from various broadcast sources, such as terrestrial broadcasts, cable broadcasts, satellite broadcasts, Internet broadcasts, and the like. The tuner may be implemented integrally with the display device 100 or may be implemented as a separate tuner electrically connected to the display device 100. The input/output unit may include at least one of a high definition multimedia interface (HDMI) input port, a component input jack, a PC input port, and a USB input jack capable of receiving image data from an external device of the display device 100 under the control of the processor 110. It is obvious to one of ordinary skill in the art that the input/output unit may be added, deleted, and/or changed according to the performance and structure of the display device 100.

According to one or more embodiments, the display 140 may perform functions for outputting information in the form of numbers, characters, images, and/or graphics. The display 140 may include at least one hardware module for output. The at least one hardware module may include at least one of, e.g., a liquid crystal display (LCD), a light emitting diode (LED), a light emitting polymer display (LPD), an organic light emitting diode (OLED), an active matrix organic light emitting diode (AMOLED), or flexible LED (FLED). The display 140 may display a screen corresponding to data received from the processor 110. The display 140 may be referred to as an ‘output unit’, a ‘display unit’, or by other terms having an equivalent technical meaning.

According to one or more embodiments, the communication unit 150 may provide a wired/wireless communication interface enabling communication with an external device. The communication unit 150 may include at least one of a wired Ethernet, a wireless LAN communication unit, and a short-range communication unit. The wireless LAN communication unit may include, e.g., Wi-Fi, and may support the wireless LAN standard (IEEE802.11x) of the institute of electrical and electronics engineers (IEEE). The wireless LAN communication unit may be wirelessly connected to an access point (AP) under the control of the processor 110. The short-range communication unit may perform short-range communication wirelessly with an external device under the control of the processor 110. Short-range communication may include Bluetooth, Bluetooth low energy, infrared data association (IrDA), ultra-wideband (UWB), and near-field communication (NFC). The external device may include a server device and a mobile terminal (e.g., phone, tablet, etc.) providing, e.g., a video service.

According to one or more embodiments, the processor 110 may control at least one other component of the display device 100 and/or execute computation or data processing regarding communication by executing at least one command 121 stored in the memory 120. The processor 110 may include at least one of a central processing unit (CPU), a graphic processing unit (GPU), a micro controller unit (MCU), a sensor hub, a supplementary processor, a communication processor, an application processor, an application specific integrated circuit (ASIC), or field programmable gate arrays (FPGA) and may have multiple cores.

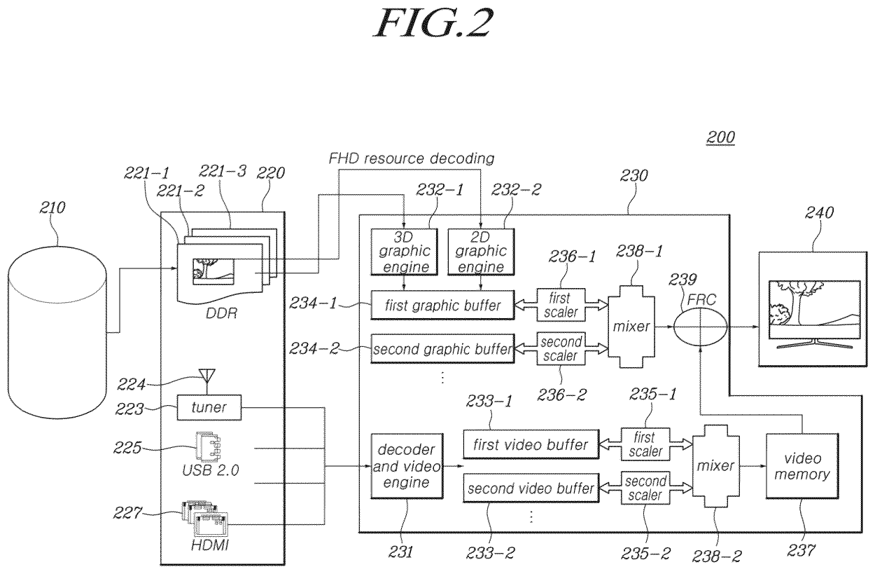

FIG. 2 is a block diagram illustrating a configuration of a display device according to one or more embodiments. The display device 200 shown in FIG. 2 may include a display device 100, and some components may correspond to each other. The block components shown in FIG. 2 may represent the block components shown in FIG. 1 in detail for parts related to the description of the disclosure.

The display device 200 according to one or more embodiments may include a storage unit 210, an input unit 220, a controller 230, and a display 240.

The storage unit 210 according to one or more embodiments may be a component corresponding to the memory 120. For example, the storage unit 210 may include a flash-type memory.

In one or more embodiments, the storage unit 210 may store graphic data displayed on the display device 200. For example, graphic data may include data regarding applications and a user interface (UI) including on-screen display (OSD) data indicating whether a function for control of the user is performed or providing information about image data.

In one or more embodiments, the graphic data may have a predetermined ratio and a predetermined resolution. For example, graphic data input to the display device 200 according to graphic data may have a resolution of FHD (full HD) and UHD (ultra HD) in a ratio of 16:9 depending on the type of graphic data.

The input unit 220 according to one or more embodiments may include an image input unit 130.

The input unit 220 according to one or more embodiments may receive image data. The image data may include video data and graphic data. Video data may mean data related to an image received from the outside, and graphic data may mean data related to a user interface displayed on the electronic device.

In one or more embodiments, the input unit 220 may include a double data rate (DDR) memory for loading graphic data obtained from the storage unit 210, an antenna 224 for receiving video data, a tuner 223 for tuning received video data, a USB port 225 for receiving data from an external device, and an HDMI (input) port 227 for receiving an external input.

In one or more embodiments, the input unit 220 may obtain the graphic data 221-1, 221-2, and 221-3 from the storage unit 210.

In one or more embodiments, the input unit 220 may store the obtained graphic data 221-1, 221-2, and 221-3 in the double data rate (DDR) memory.

In one or more embodiments, the input unit 220 may receive an image signal through the antenna 224.

In one or more embodiments, the tuner 223 may tune and select only the frequency of the broadcast channel to be received by the display device 100 among the radio wave components through amplification, mixing, and resonance of the broadcast signal received wirelessly or wired.

In one or more embodiments, the input unit 220 may receive image data from an external device through the USB (input) port 225.

In one or more embodiments, the input unit 220 may receive image data from an external device through the HDMI port 227.

In one or more embodiments, the controller 230 may include graphic processing units 232-1 and 232-2, a plurality of graphic buffers 234-1, 234-2, . . . , a plurality of scalers 236-1 and 236-2, a mixer 238, an FRC 239, a video processing unit 231, and a video memory 237. Other components may be added in addition to the components shown in FIG. 2, and some components may be omitted in some cases.

In one or more embodiments, the controller 230 may obtain graphic data from the input unit 220. For example, the 3D graphic engine 232-1 may obtain 3D graphic data from the input unit 220. For example, the 2D graphic engine 232-2 may obtain 2D graphic data from the input unit 220.

In one or more embodiments, the graphic processing unit (e.g., the 3D graphic engine 232-1 or the 2D graphic engine 232-2) may render the graphic data to a graphic buffer (e.g., the first graphic buffer 234-1 or the second graphic buffer 234-2). Although only two graphic buffers are illustrated in FIG. 2, this is merely an example and there may be more than two graphic buffers.

In one or more embodiments, the plurality of scalers (e.g., the first scaler 236-1 and the second scaler 236-2) may perform upscaling on graphic data rendered to the plurality of graphic buffers (e.g., the first graphic buffer 234-1 and the second graphic buffer 234-2).

In one or more embodiments, the specification of the scaler may include, e.g., the resolution of the original resource that may be processed (e.g., up to 2K (FHD, 1920*1080) or up to 4K (UHD, 3840*2160), and the scaling ratio (e.g., whether it supports only a fixed scale ratio (integer multiple). For example, if the scaler's specification is limited to a specific resolution or is set to a specific bandwidth (B/W) or fixed scale ratio, the scaler may not be able to scale graphic data with a specific resolution of a specific proportion. In this case, the electronic device may downscale the original data rendered to the graphic buffer to a resolution of the rate at which the scaler may perform scaling and then perform upscaling again.

In one or more embodiments, the mixer 238-1 may mix data upscaled from the plurality of scalers (e.g., the first scaler 236-1 and the second scaler 236-2).

In one or more embodiments, the video processing unit 231 may process video data received from the input unit 220.

In one or more embodiments, the video processing unit 231 may render video data to a video buffer (e.g., the first video buffer 233-1 or the second video buffer 233-2). Although only two video buffers are illustrated in FIG. 2, this is merely an example and there may be more than two video buffers.

In one or more embodiments, the plurality of scalers (e.g., the first scaler 235-1 and the second scaler 235-2) may perform upscaling on video data rendered to the plurality of video buffers (e.g., the first video buffer 233-1 and the second video buffer 233-2). The upscaling of the plurality of scalers 235 may correspond to the above-described upscaling method of the graphic scaler.

In one or more embodiments, the mixer 238-2 may mix the data upscaled from the plurality of scalers (e.g., the first scaler 235-1 and the second scaler 235-2). In one or more embodiments, the mixed video data may be transmitted to the video memory 237.

In one or more embodiments, the frame rate conversion (FRC) 239 may mix graphic data received from the mixer 238-1 and video data received from the video memory 237 and transmit the same to the display 240.

According to one or more embodiments, the display 240 may output the received data on the screen. For example, the display 240 may be a component for showing data received through low-voltage differential signaling (LVDS) to the user through the panel of the display. A mixed screen of a frame ratio-adjusted video and graphic may be output through the display 240.

As described in FIG. 2, the graphic system of a DTV and monitor may use resources of a specific resolution (FHD for a 4K TV, or UHD for an 8K TV) to render the same to a graphics buffer, and perform upscaling in the graphic hardware (HW) and displayed on the screen. Each graphic buffer is connected to a scaler, so that the image of each graphic buffer may be scaled to the screen size and output to the panel through the mixer. For example, in order to output graphic from a UHD TV, FHD resources stored in a flash may be loaded into DDR memory, and an application may render the resources loaded into the DDR memory to the FHD graphic buffer using the GPU, CPU, or graphic HW. The rendered graphic buffer may be upscaled FHD->UHD by the HW and output on the final screen in the UHD size. However, rather than the scaler being connected to only one graphic buffer, a plurality of scalers may be connected to one graphic buffer.

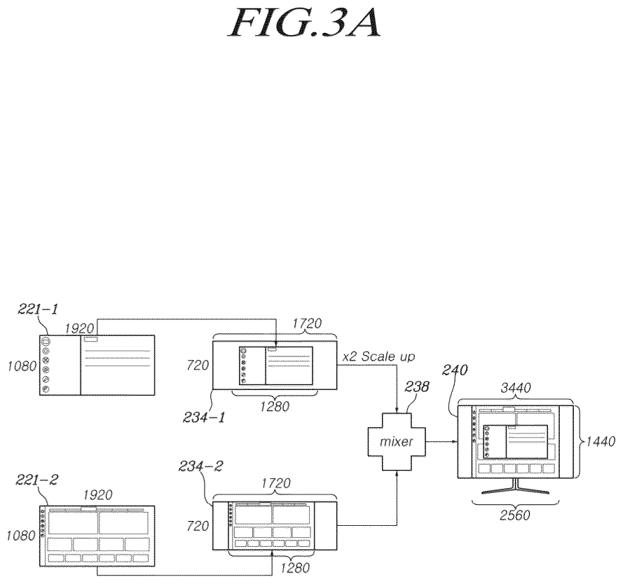

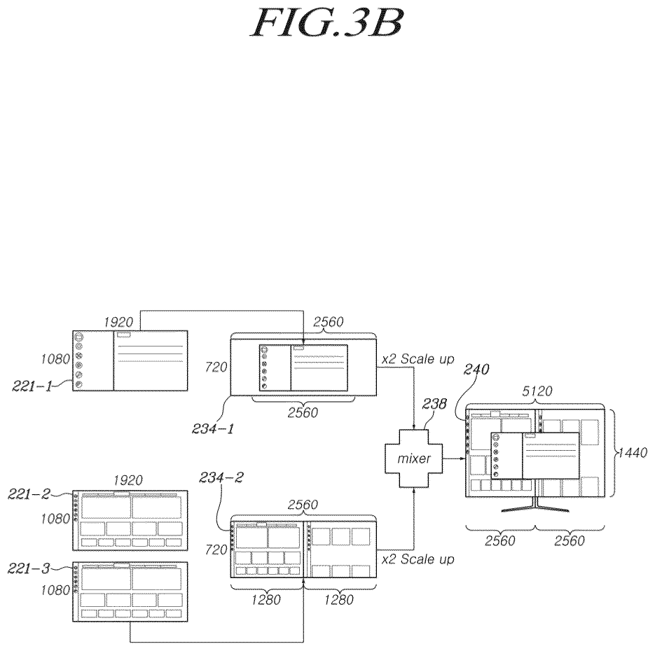

FIG. 3A illustrates an example of upscaling of a display device according to one or more embodiments. FIG. 3B illustrates an example of upscaling of a display device according to one or more embodiments. The display device described in FIGS. 3A and 3B may be a device corresponding to the display device 100 of FIG. 1 and the display device 200 of FIG. 2.

In one or more embodiments, the display device may determine the size of the graphic buffer considering the ratio of the original resource, the resolution, and the ratio and resolution of the screen to be output.

For example, in a display system with a graphic engine structure that upscales an original graphic with a 16:9 FHD resolution to a graphic with a UHD resolution, it is necessary to generate graphic data having a 21:9 WQHD resolution based on the original graphic data having a 16:0 FHD resolution for the display device to output the 21:9 WQHD (3440×1440) graphic. In this case, since the ratio of the graphic buffer to be scaled should be maintained at 21:9, the buffer size may be determined as 3440×1440. Further, when the display device 200 finally outputs an FHD resolution graphic with a ratio of 16:9, the FHD resolution graphic may be placed in the center of the graphic buffer generated at a ratio of 21:9 to be displayed at a ratio of 16:9. Therefore, the final buffer output size may have a buffer size of 2560*1080 with respect to the height (i.e., 1080).

For example, in a display system with a graphic engine structure that upscales an original graphic with a 16:9 FHD resolution to a graphic with a UHD resolution, it is necessary to generate graphic data having a 32:9 DQHD resolution based on the original graphic data having a 16:0 FHD resolution for the display device to output the 32:9 DQHD (5120×1440) graphic. In this case, since the ratio of the graphic buffer to be scaled should be maintained at 32:9, the buffer size may be determined as 5120×1440. Further, when the display device 200 finally outputs an FHD resolution graphic with a ratio of 16:9, the FHD resolution graphic may be placed in the center of the graphic buffer generated at a ratio of 32:9 to be displayed at a ratio of 16:9. Therefore, the final buffer output size may have a buffer size of 3840*1080 with respect to the height (i.e., 1080).

In this regard, if the specification of the scaler is limited to a specific resolution or is set to a B/W or fixed scale ratio, the scaler may not be able to process a specific resolution with a specific ratio. In other words, in a display device that processes multi-resolution and multi-ratio, the display device may render graphic data to the graphic buffer at a ratio according to a fixed rate of resolution and ratio to support the same. If upscaling may not be performed on data rendered to the graphic buffer due to the specifications of the scaler, downscaling may be performed, and image quality may be degraded in the process.

Referring to FIG. 3A, as an example, in a system in which the graphic scaler supports up to only FHD (1920*1080), in order to output normal graphic on the display 240 when the display 240 of the display device displays 21:9 WQHD, the size of the graphic buffer 234-1 for the first graphic data 221-1 should be determined as 2560×1080 but, due to the specifications of the scaler, the size of the graphic buffer 234-1 may be determined as 1720*720. Likewise, the size of the graphic buffer 234-2 for the second graphic data 221-2 should be 2560×1080 but, due to the specifications of the scaler, the size of the graphic buffer 234-1 may be determined as 1720*720. Accordingly, the graphic data 221-1 and 221-2 rendered to the graphic buffers 234-1 and 234-2 each may be downsized to 1280*720, causing image quality degradation.

Referring to FIG. 3B, in a system in which the graphic scaler has a scale ratio of an integer multiple, for the display 240 of the display device to output normal graphic on the display 240 having a DQHD of a 32:9 ratio, the size of the graphic buffer 234-1 for the first graphic data 221-1 should be 3840*1080 but, since the upscaling ratio to 3840×1080 or 5120×1440 is 1.3 times, i.e., not an integer multiple, upscaling may not be performed. Therefore, for normal graphic output, the buffer size should be determined as 2560×720, so that the original graphic data is downsized, causing degradation of image quality. In the following description, a display device and an operation method thereof, for minimizing degradation of image quality due to downsizing on the original graphic data are described.

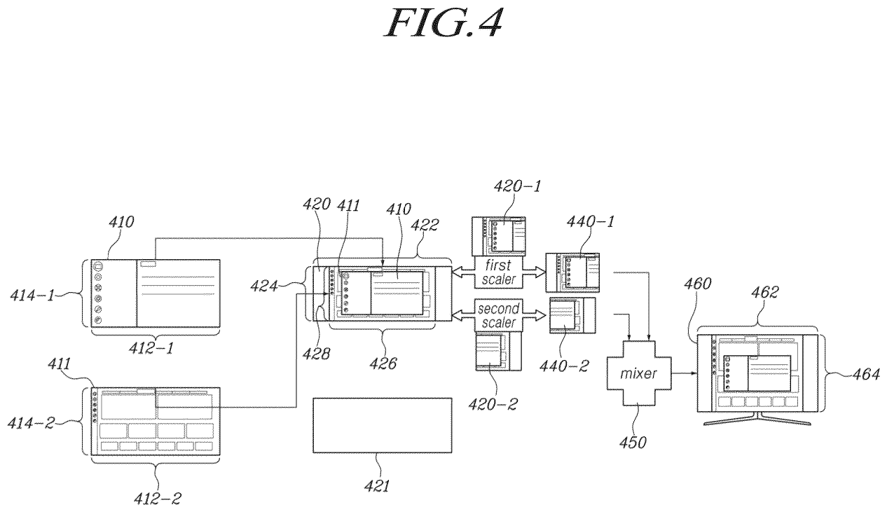

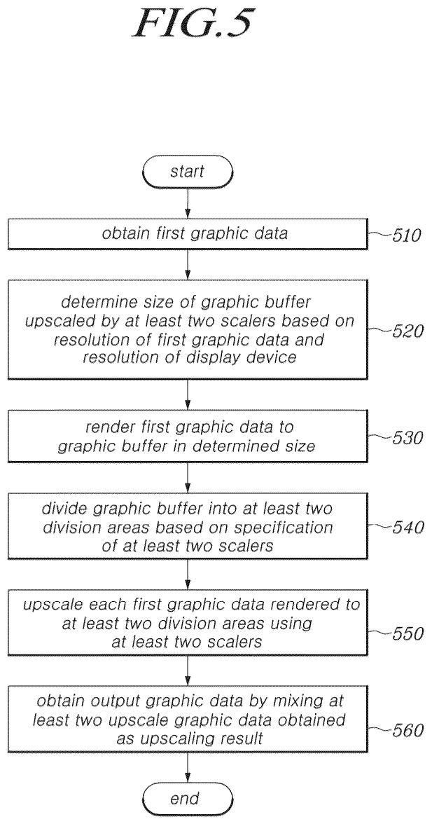

FIG. 4 illustrates an example of upscaling of a display device according to one or more embodiments. FIG. 5 illustrates an operation flow of a display device according to one or more embodiments. FIG. 4 illustrates an operation flow of the display device according to FIG. 5. The display device described in FIGS. 4 and 5 may correspond to the display device of FIGS. 1, 2, 3A, and 3B.

According to one or more embodiments, in operation 510, the display device may obtain first graphic data 410 from the memory. Graphic data may include data regarding applications and a user interface (UI) including on-screen display (OSD) data indicating whether a function for control of the user is performed or providing information about image data.

In one or more embodiments, the display device may obtain second graphic data 411 to be displayed on the screen together with the first graphic data 410. The second graphic data 411 may represent data related to a graphic different from that of the first graphic data 410, and the first graphic data 410 and the second graphic data 411 may be superposed and displayed. For example, the first graphic data 410 may be displayed on a lower layer, and the second graphic data 411 may be data displayed on an upper layer of the first graphic data 410 at a central position. The following description relates to an operation of performing upscaling on the first graphic data 410, but this is merely an example, and the operation according to the disclosure may be equally applied not only to the first graphic data 410 but also to the second graphic data 411 or data in which the first graphic data 410 and the second graphic data 411 overlap each other, and third graphic data other than the first graphic data 410 and the second graphic data 411.

In one or more embodiments, the horizontal length 412-1 of the first graphic data 410 and the vertical length 414-1 of the first graphic data may have a first ratio. In one or more embodiments, the horizontal length 412-2 of the second graphic data 411 and the vertical length 414-2 of the second graphic data 411 may have a second ratio. In one or more embodiments, the first ratio and the second ratio may be determined according to attributes of the application.

In one or more embodiments, the resolutions of the first graphic data 410 and the second graphic data 411 may have resolutions corresponding to the first ratio and the second ratio, respectively. For example, when the first ratio is 16:9, the resolution of the first graphic data may be HD (1280×720), FHD (1920×1080), QHD (2560×1440), 4K UHD (3840×2160), or 8K UHD (7680×4320). When the second ratio is 16:9, the resolution of the second graphic data may be HD (1280×720), FHD (1920×1080), QHD (2560×1440), 4K UHD (3840×2160), or 8K UHD (7680×4320).

According to one or more embodiments, in operation 520, the display device may determine the size of the graphic buffer upscaled by at least two scalers based on the resolution of the first graphic data and the resolution of the display device. The graphic buffer may mean a memory for rendering the next graphic to be displayed on the display by the graphic processing unit. The graphic buffer may be a memory that may be indexed as (x,y) coordinates. Each pair of coordinates may correspond to one pixel. In the description of the disclosure, a graphic buffer where graphic data is rendered is described as an example, but the same content may be applied to a video buffer where video data is rendered.

In one or more embodiments, the size of the graphic buffer may represent information about the horizontal length of the graphic buffer, the vertical length of the graphic buffer, and the ratio of the horizontal length to the vertical length of the graphic buffer.

In one or more embodiments, the display device may include a plurality of graphic buffers. FIG. 4 illustrates only two graphic buffers (e.g., the first graphic buffer 420 and the second graphic buffer 421), but this is merely an example and more than two graphic buffers may exist.

In one or more embodiments, the horizontal length 422 and the vertical length 424 of the graphic buffer may be determined based on the horizontal length 426 and the vertical length 428 of the original graphic data (e.g., the first graphic data 410 and the second graphic data 411) and the horizontal length 462 and the vertical length 464 of the display 460.

In one or more embodiments, the ratio of horizontal length to vertical length of the first graphic buffer 420 (hereinafter, referred to as a ratio) may correspond to the ratio of the display 460, and the vertical length 424 of the first graphic buffer 420 may correspond to the vertical length 414-1 of the first graphic data 410. For example, when the display 460 has a size of 3440*1440 in a 21:9 ratio, the first graphic buffer 420 may have a size of 2560*1080 in a 21:9 ratio. For example, when the display 460 has a size of 5120*1440 in a 32:9 ratio, the first graphic buffer 420 may have a size of 3840*1080 in a 32:9 ratio.

According to one or more embodiments, the display device may render the first graphic data to a graphic buffer having a determined size.

In one or more embodiments, referring to FIG. 4, the display device may render the first graphic data 410 to the first graphic buffer 420. In one or more embodiments, the display device may render the second graphic data 411 to the first graphic buffer 420. In one or more embodiments, the display device may superpose and dispose the first graphic data 410 and the second graphic data 411 in the first graphic buffer 420. In one or more embodiments, the display device may render the first graphic data 410 and the second graphic data 411 with them superposed in the center of the first graphic buffer 420.

According to one or more embodiments, in operation 540, at least two division areas constituting the graphic buffer may be identified based on the specifications of the scaler.

In one or more embodiments, the at least two division areas of the first graphic buffer 420 may include a first area 420-1 configuring a first direction with respect to the center of the vertical axis of the first graphic buffer 420 and a second area 420-2 configuring a second direction opposite to the first direction. In other words, first area 420-1 may be on a first side of the vertical axis and second area 420-2 may be on a second side of the vertical axis, opposite the first side.

According to one or more embodiments, in operation 550, the display device may perform upscaling on data rendered to at least two division areas using at least two scalers.

According to one or more embodiments, in operation 560, the display device may obtain output graphic data by mixing at least two upscale graphic data obtained as a result of upscaling. The output graphic data may mean graphic data displayed on the display unit of the display device.

According to one or more embodiments, the display device may receive video data from the image input unit. According to one or more embodiments, the display device may decode the video data to obtain the output video data. In one or more embodiments, the display device may combine output video data and output graphic data and display the same on the display.

For example, when the display device outputs graphic data with a 16:9 FHD resolution to a 21:9 display, the display device may render it to the center of the first graphic buffer 420 having a size of 2650*1080 using the GPU to normally output the size of the graphic buffer. After rendering is completed, the display device may identify the first area and the second area as the first area and second area having a size of 1280*1080 in the first graphic buffer 420 using the first scaler and the second scaler. For (x,y) values, the first scaler may perform upscaling on data from (0,0) to (1280, 1080), and the second scaler may perform upscaling from (1281, 0) to (2560, 1080). Through this method, the 2560*1080 buffer may be cropped through the scaler without data loss. Each of the division areas (the first area 420-1 and the second area 420-2) may upscale each 1280*1080 area to 1720*1440 for normal output to the 3440*1440 panel of the display 460. Each upscaled graphic data may be input to the mixer 450, and the mixer 450 may mix each upscaled graphic data into one graphic data. The 16:9 FHD original image may be disposed in the center of the display 460 of the 3440×1440 specification through mixed data without degradation of image quality and may be output. The above-described operations of the display device may be applied not only when the original image has a ratio of 16:9 but also when the original image has a resolution of another ratio.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, or a home appliance. According to one or more embodiments of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to one or more embodiments, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the display device 200 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. A display device, comprising:
memory storing instructions; and
at least one processor operatively connected to the memory and comprising at least one graphic buffer and at least two scalers, wherein the at least one processor is configured to execute the instructions to:
obtain first graphic data from the memory;
determine a size of the at least one graphic buffer to be upscaled by the at least two scalers, based on a resolution of the first graphic data and a resolution of the display device;
render the first graphic data to the at least one graphic buffer to generate rendered data;
divide the at least one graphic buffer into at least two division areas based on a specification of the at least two scalers;
upscale the rendered data of the at least two division areas using the at least two scalers to obtain at least two upscale graphic data;
obtain output graphic data by mixing the at least two upscale graphic data; and
control the display device to display the output graphic data.

2. The display device of claim 1, wherein the at least one processor is further configured to execute the instructions to:
obtain second graphic data from the memory; and
render the first graphic data and the second graphic data to the at least one graphic buffer.

3. The display device of claim 2, wherein the at least one processor is further configured to execute the instructions to:
superpose and render the first graphic data and the second graphic data at a center position of the at least one graphic buffer.

4. The display device of claim 1, wherein the at least one graphic buffer has a ratio corresponding to the resolution of the display device.

5. The display device of claim 4, wherein the resolution of the first graphic data is a first ratio (16:9), and the resolution of the display device is either a second ratio (21:9) or a third ratio (32:9).

6. The display device of claim 5, wherein the at least two division areas of the at least one graphic buffer comprise a first area and a second area, the first area being on a first side of a vertical axis of the at least one graphic buffer, and the second area being on a second side of the vertical axis opposite the first side.

7. The display device of claim 6, wherein a horizontal length of the at least two upscale graphic data is identical to a half of a horizontal length of the resolution of the display device, and a vertical length of the at least two upscale graphic data is identical to a vertical length of the resolution of the display device.

8. The display device of claim 1, further comprising:
a display; and
an image input interface,
wherein the at least one processor is further configured to execute the instructions to:
receive video data from the image input interface;
decode the video data to obtain output video data; and
control the display to display a screen in which the output video data and the output graphic data are combined.

9. The display device of claim 1, wherein the specification of the at least two scalers comprises resolutions of the at least two scalers and information about whether the at least two scalers support integer-multiple upscaling.

10. The display device of claim 9, wherein the at least two scalers have a same specification.

11. A method for operating a display device, the method comprising:
obtaining first graphic data from memory;
determining a size of at least one graphic buffer to be upscaled by at least two scalers, based on a resolution of the first graphic data and a resolution of the display device;
rendering the first graphic data to the at least one graphic buffer to generate rendered data;
dividing the at least one graphic buffer into at least two division areas based on a specification of the at least two scalers;
upscaling the rendered data of the at least two division areas using the at least two scalers to obtain at least two upscale graphic data;
obtaining output graphic data by mixing the at least two upscale graphic data; and
displaying the output graphic data using the display device.

12. The method of claim 11, further comprising:
obtaining second graphic data from the memory; and
rendering the first graphic data and the second graphic data to the at least one graphic buffer.

13. The method of claim 12, further comprising:
superposing and rendering the first graphic data and the second graphic data at a center position of the at least one graphic buffer.

14. The method of claim 11, wherein the at least one graphic buffer has a ratio corresponding to the resolution of the display device.

15. The method of claim 14, wherein the resolution of the first graphic data is a first ratio (16:9), and the resolution of the display device is either a second ratio (21:9) or a third ratio (32:9).

16. The method of claim 15, wherein the at least two division areas of the at least one graphic buffer comprise a first area and a second area, the first area being on a first side of a vertical axis of the at least one graphic buffer, and the second area being on a second side of the vertical axis opposite the first side.

17. The method of claim 16, wherein a horizontal length of the at least two upscale graphic data is identical to a half of a horizontal length of the resolution of the display device, and a vertical length of the at least two upscale graphic data is identical to a vertical length of the resolution of the display device.

18. The method of claim 11, wherein the display device comprises a display and an image input interface, the method further comprising:
receiving video data from the image input interface;
decoding the video data to obtain output video data; and
displaying a screen in which the output video data and the output graphic data are combined on the display.

19. The method of claim 11, wherein the specification of the at least two scalers comprises resolutions of the at least two scalers and information about whether the at least two scalers support integer-multiple upscaling.

20. The method of claim 19, wherein the at least two scalers have a same specification.
